(19) United States
(12) Patent Application Publication
(10) Pub. No.: US 2024/0246198 A1
(43) Pub. Date: Jul. 25, 2024

(54) METHOD FOR PRODUCING A CERAMICALLY BONDED GRINDING TOOL

(71) Applicant: TYROLIT - SCHLEIFMITTELWERKE SWAROVSKI AG & Co K.G., Schwaz (AT)

(72) Inventors: Gernot KALTENHAUSER, Schwaz (AT); Burghard PILLINGER, Hart im Zillertal (AT)

(21) Appl. No.: 18/289,955

(22) PCT Filed: Apr. 25, 2022
(86) PCT No.: PCT/AT2022/060128

§ 371 Date: Nov. 8, 2023

(30) Foreign Application Priority Data
May 12, 2021 (AT) A 50362/2021

(51) Int. Cl. B24D 3/14; B24D 18/00

(52) U.S. Cl. CPC B24D 3/14; B24D 18/0009

(57) ABSTRACT

A method for producing a ceramically bonded grinding tool includes, in chronological order, mixing a grinding agent, an inorganic binding agent, and an organic binding agent. The grinding agent, the inorganic binding agent, and the organic binding agent are pre-pressed in a cold-pressing step to form a cold-pressed green body. The cold-pressed green body is pressed in a hot-pressing step to form a hot-pressed green body. The hot-pressed green body is burned in a burning step to form a grinding tool blank. The organic binding agent is at least partly burned off during the burning step, and the grinding tool blank is post-processed in a subsequent step to form the grinding tool, into which the grinding agent is incorporated.

The invention relates to a method for producing a ceramically bonded grinding tool, in particular a honing ring. The invention further relates to a ceramically bonded grinding tool, in particular a honing ring, comprising a main body and at least one abrasive that is embedded in the main body by means of at least one inorganic bonding material.

A grinding tool in the form of a honing ring is already known from EP 0 692 342 A2, in which, during the production process for the honing ring, bonding material in the form of synthetic resin comprising fine-grained abrasive and ceramically bonded coarse-grained abrasive is blended in order to be able to ensure greater ultimate strength in the resulting honing ring by way of reduced brittleness due to the integrated synthetic resin.

By way of example, ceramically bonded grinding tools are manufactured in a cold-pressing method, wherein in particular a service life and/or machining properties of the produced grinding tool are highly dependent on a grain volume and/or a bond volume relative to a pore volume of the grinding tool. In practice, bonding agent systems in the form of dextrins have proved to be advantageous but have been found to be inadequate when producing particularly dense specifications.

A disadvantage of the state of the art is that in practice grinding tools having a particularly high grain volume and/or bond volume cannot be produced merely by modifying the specifications, such as increasing the grain proportion and/or the bond proportion in grinding tool blanks, in particular because presses for a required compressing of the grinding tool blanks are not strong enough. However, a high grain volume and/or bond volume is essential for grinding tool properties such as a long service life or advantageous dressing characteristics, wherein these cannot be adequately obtained in the state of the art.

The objective technical problem of the present invention is therefore to disclose a method for producing a ceramically bonded grinding tool, improved compared with the state of the art, as well as a ceramically bonded grinding tool, in which the disadvantages of the state of the art are at least partly remedied and which are characterized in particular by a high grain volume and/or bond volume in the grinding tool in order to be able to increase the service life and/or enhance the machining properties of the grinding tool.

This problem is solved by the features of claim 1.

Accordingly, it is provided according to the invention that the method comprises the following method steps, to be carried out in chronological order:
in a first method step, at least one abrasive, in particular corundum, SiC, aluminum oxide, and/or a superabrasive, at least one inorganic bonding material, in particular formed as a low-temperature baking bond, and at least one organic bonding material, in particular in the form of epoxy resin, are provided and blended,
the at least one abrasive, the at least one inorganic bonding material and the at least one organic bonding material are pre-pressed in a cold-pressing step to form a cold-pressed green body,
the cold-pressed green body is pressed in a hot-pressing step to form a hot-pressed green body,
the hot-pressed green body is fired in a firing step to form a grinding tool blank, in particular a honing ring blank, wherein the at least one organic bonding material is at least partly burned off during the firing step, and
the grinding tool blank is post-processed in a subsequent method step to form the grinding tool, in which abrasive is embedded.

This two-stage pressing process with subsequent firing process makes it possible to generate very dense specifications with a greater grain volume and bond volume compared with the state of the art. The grinding tool blanks and grinding tools produced by the method are particularly suitable for demanding grinding work, wherein the pressure resistance, hardness, wear behavior, etc. are in particular improved compared with ceramically bonded grinding tools manufactured in the conventional manner.

Through the increased grain proportion and bond proportion, long service lives can be achieved even in grinding work that is tough on the grinding tool. For example, by determining the density of the grinding tool, in particular when the composition of the grinding tool is known, the prevailing specification of the grinding tool can be deduced. Even microscopic analyses of the grinding tool may be enough to ascertain the prevailing grain volume, bond volume and pore volume of the grinding tool.

The technical term “green body” is defined in this context as a blank during the production process for forming the grinding tool blank, wherein the cold-pressed green body, the hot-pressed green body and the grinding tool blank can be removed from a press mold or a furnace in a dimensionally stable form.

Generally, the post-processing of the grinding tool blank can be as required to form the grinding tool and can include, for example, the machining steps of pounding, scraping, milling, or the like. In the honing rings produced according to the invention, performance in relation to dressing cycles was able to be increased significantly (by 300%) compared with customary ceramically bonded honing rings with high densities known from the state of the art.

Instead of the dextrins typically used as bonding agents for grinding tools or honing rings in practice, according to the invention an organic bonding material, particularly preferably represented by epoxy resin or synthetic resin, is used as bonding agent. The advantage of this is that pressing steps from the production of synthetic-resin-bonded grinding tools can also be applied to ceramically bonded grinding tools in order to be able to form particularly dense specifications of grinding tools, wherein increases in the grain volume and/or bond volume in ceramically bonded grinding tools are restricted by means of presses, in particular at room temperatures, through a physical and practically limited compression.

The grain volume and bond volume can be increased in particular by the burning-off process of the organic bonding material and the fusing of the inorganic bonding material. For example, the mixture prepared for the cold-pressing operation contains 50 vol. % to 65 vol. %, preferably 55 vol. %, grain volume and 10 vol. % to 35 vol. %, preferably 22 vol. %, bond volume, which, in conjunction with a pore volume formed production-dependent, can manifest themselves at 55 vol. % grain volume and 20 vol. % bond volume in the grinding tool blank, wherein the grinding tool blank is highly suitable for demanding abrasive grinding work.

As stated at the outset, protection is also sought for a ceramically bonded grinding tool, in particular a honing ring, comprising
a main body and
at least one abrasive that is embedded in the main body by means of at least one inorganic bonding material, wherein
a grain volume of the abrasive is in the range between 50 vol. % and 65 vol. %, in particular between 53 vol. % and 58 vol. %, and
a bond volume of a bonding material is in the range between 10 vol. % and 35 vol. %, in particular between 18 vol. % and 26 vol. %,
   of the grinding tool, wherein the grain volume and the bond volume together amount to at most 100 vol. % of the grinding tool.

Differences between a sum of grain volume and bond volume (inorganic bonding material and any organic bonding material) in relation to the total volume of the grinding tool can exist in the form of a pore volume, for example.

It is particularly preferably provided that the grinding tool is produced by a method of this kind.

Advantageous embodiments of the invention are defined in the dependent claims.

According to an advantageous embodiment of the invention, it is provided that the at least one organic bonding material is substantially entirely burned off during the firing step and/or is burned off to the extent that an organic bond volume is at most 15 vol. %, preferably at most 10 vol. %, of the grinding tool blank.

The proportion of organic bonding material used for the two-stage pressing method when using pressing processes from synthetic-resin-bonded grinding tools can be reduced in the firing step, wherein it is possible to adjust a quantity of residual organic bonding material via operating parameters (for example pressure and/or temperature) in the firing step depending on requirements placed on the grinding tool (for example desired damping properties owing to remnants of the epoxy resin).

Advantageously, it is provided that the cold-pressing step and the hot-pressing step are carried out in separate press molds, wherein it is preferably provided that the press mold and/or the cold-pressed green body is/are pre-heated for the hot-pressing step.

Preferably, two press molds are used, wherein the press mold of the hot-pressing step is pre-heated before, during or after the cold-pressing operation so that a pre-heated cold-pressed green body is placed in this press mold. Generally, it is also conceivable to pre-heat only the press mold or the green body.

It has proved favorable for the cold-pressed green body to be pressed to a first extent in the cold-pressing step and for the hot-pressed green body to be pressed to a second extent that is different from the first extent in the hot-pressing step, wherein it is preferably provided that the hot-pressed green body is pressed to an external diameter between 50 mm and 450 mm, an internal diameter between 20 mm and 300 mm, and/or a width between 10 mm and 90 mm.

In this case, the press mold of the cold-pressing step takes account of a shrinkage in the further process steps, wherein the cold-pressed green body is compressed further in the hot-pressing step in order to be able to produce a grinding tool blank with desired dimensions after the firing step.

According to an advantageous embodiment of the invention, it is provided that the at least one organic bonding material is substantially entirely cross-linked in the hot-pressing step.

Generally, the at least one inorganic bonding material, by contrast with the at least one organic bonding material, is not yet fused during the hot-pressing owing to the prevailing temperatures.

It has proved advantageous for the at least one inorganic bonding material to be fused in the firing step, wherein it is preferably provided that the firing step is carried out in a furnace.

Through the high temperatures in the firing step, the at least one bonding material burns off at least in part, preferably entirely, and the grinding tool blank with a high grain volume and/or bond volume forms by means of the bonding of the at least one abrasive to the at least one inorganic bonding material.

In an advantageous variant, a pressure between 20 bar and 300 bar, preferably between 40 bar and 60 bar, and/or substantially room temperature is/are used in the cold-pressing step.

Through the cold-pressing step, a dimensionally stable cold-pressed green body with a substantially homogeneous mixture of the fed-in constituents can be obtained for further processing.

Particularly preferably, a pressure between 270 bar and 310 bar, preferably 275 bar to 285 bar, and/or a temperature between 150° C. and 200° C., preferably between 170° ° C. and 180° C., is/are used in the hot-pressing step.

Through the hot-pressing step, a dimensionally stable hot-pressed green body can be brought about for the firing step, with cross-linked organic bonding material and existing inorganic bonding material.

In an embodiment example of the invention, the firing step is carried out at a temperature between 600° C. and 1300° C., preferably between 900° ° C. and 1000° C.

Depending on the selection of the constituents of the organic and/or inorganic bonding materials, a suitable temperature can be selected that ensures a stable bond, in particular of the at least one inorganic bonding material to the at least one abrasive, wherein the temperature is preferably selected such that the at least one organic bonding material burns off at least in part, preferably entirely, during the firing step and the at least one inorganic bonding material during the firing step, preferably substantially entirely, in order to embed the at least one abrasive, wherein no undesirable temperature-related damage (such as oxidation or the formation of lumps liable to chip owing to excessively high temperatures) is suffered by the at least one inorganic bonding material and abrasive.

According to a preferred embodiment example of the invention, it is provided that, starting from a grain volume of an abrasive, a bond volume of the bonding materials, and/or a pore volume of the cold-pressed green body after the cold-pressing step, as a result of the hot-pressing step and/or the firing step:
the grain volume of the grinding tool blank is increased to a range between 50 vol. % and 65 vol. %, preferably between 53 vol. % and 58 vol. %, and/or
a bond volume of the grinding tool blank is increased to a range between 10 vol. % and 35 vol. %, preferably between 18 vol. % and 26 vol. %, and/or
a pore volume of the grinding tool is reduced to a range between 10 vol. % and 40 vol. %, preferably between 22 vol. % and 28 vol. %,
   wherein the grain volume, the bond volume and the pore volume of the hot-pressed green body and/or of the grinding tool blank together amount to at most 100 vol. %.

Through an increased grain volume and an increased bond volume, a grinding tool that is dense, solid, stable and/or resistant in particular to wear and/or tool breakage can be produced.

Furthermore, it is preferably provided that the main body is annular and/or formed in one piece, wherein it is preferably provided that the main body has teeth on an inner lateral surface and/or on an outer lateral surface, which teeth can be brought into contact with a toothed workpiece.

In a further embodiment, it can be provided that the at least one abrasive is formed at least in part, preferably entirely, of corundum, preferably high-grade corundum and/or sintered corundum, sic, oxide, aluminum and/or a superabrasive, preferably diamond and/or cubic boron nitride.

The technical term “superabrasive” is defined in this context as an abrasive with particularly favorable abrasive properties and/or particularly high hardnesses, as is the case with diamond and cubic boron nitride (CBN), for example. By way of example, gearwheels can be honed using the grinding tool.

According to an advantageous embodiment of the invention, it is provided that the grinding tool has at most 15 vol. %, preferably at most 10 vol. %, organic bond volume, wherein it is preferably provided that the organic bond volume is formed from the group of thermoplastics and/or thermosets, particularly preferably substantially epoxy resin.

Thermoplastics and/or thermosets have proved particularly favorable for producing grinding tools using the two-stage production method according to the invention, wherein epoxy resin has particularly advantageous properties in terms of bonding power and thermal behavior during the hot-pressing step and firing step.

According to an advantageous embodiment of the invention, it is provided that the grinding tool comprises at least one, preferably exactly one, inorganic bonding material, wherein the at least one inorganic bonding material is in the form of a low-temperature baking bond.

One example of low-temperature baking bonds is synthetic, technical glass, which is resistant to chemical effects and has an unlimited shelf life. Owing to their characteristic material properties and processability, low-temperature baking bonds have proved particularly favorable in the production of grinding tools.

Advantageously, it is provided that the at least one inorganic bonding material comprises SiO₂, Al₂O₃, B₂O₃, and/or at least one oxide comprising an alkali and/or alkaline earth.

As a result, high hardnesses and strengths of the grinding tool are obtained even at low furnace temperatures, wherein a bond to the at least one abrasive, in particular diamond, cubic boron nitride, and/or sintered corundum, is able to be produced particularly effectively.

Generally, however, other inorganic bonding materials are also conceivable, wherein particularly preferably inorganic bonding materials that do not burn off during the firing step owing to their adequate temperature resistance are used.

It has proved favorable for the grinding tool to have an external diameter between 50 mm and 450 mm, an internal diameter between 20 mm and 300 mm, and/or a width between 10 mm and 90 mm.

According to an advantageous embodiment of the invention, it is provided that the grinding tool comprises a pore volume in the range between 10 vol. % and 40 vol. %, preferably between 22 vol. % and 28 vol. %, wherein the grain volume, the bond volume and the pore volume together amount to at most 100 vol. % of the grinding tool.

An effective reduction in the pore volume is particularly preferable for providing high densities of the grinding tool, wherein the pore volume prevailing in the grinding tool can to a certain extent have the effect that forces acting on the grinding tool during an abrasive machining process are damped.

The features of the method claims are applicable to the device claims, and vice versa.

Further details and advantages of the present invention are explained in more detail below with the aid of the description of the figures with reference to the embodiment examples shown in the drawings. There are shown in:

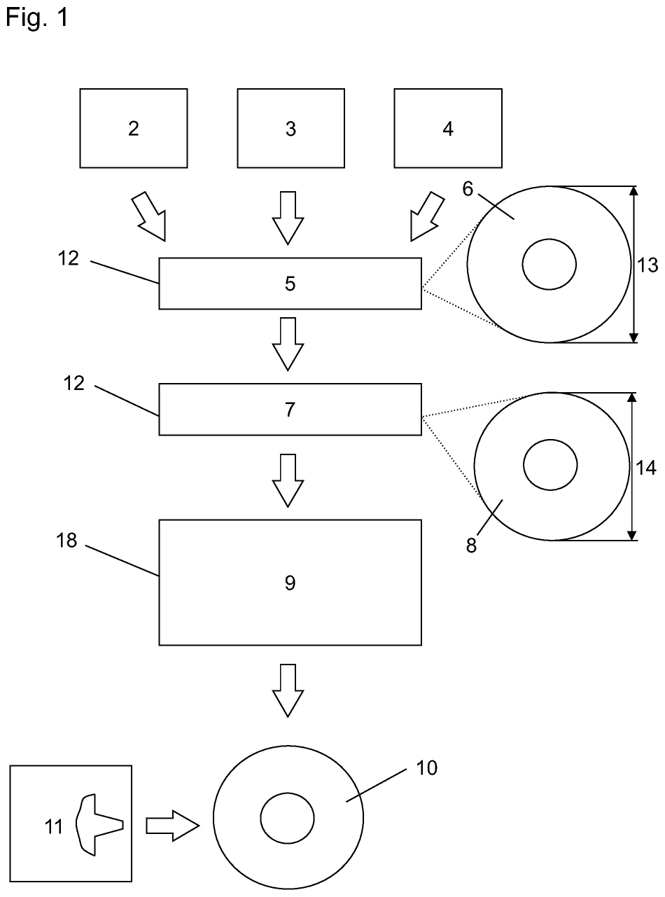

FIG. 1 a schematic representation in a flowchart of a preferred sequence of a method for producing a ceramically bonded grinding tool,

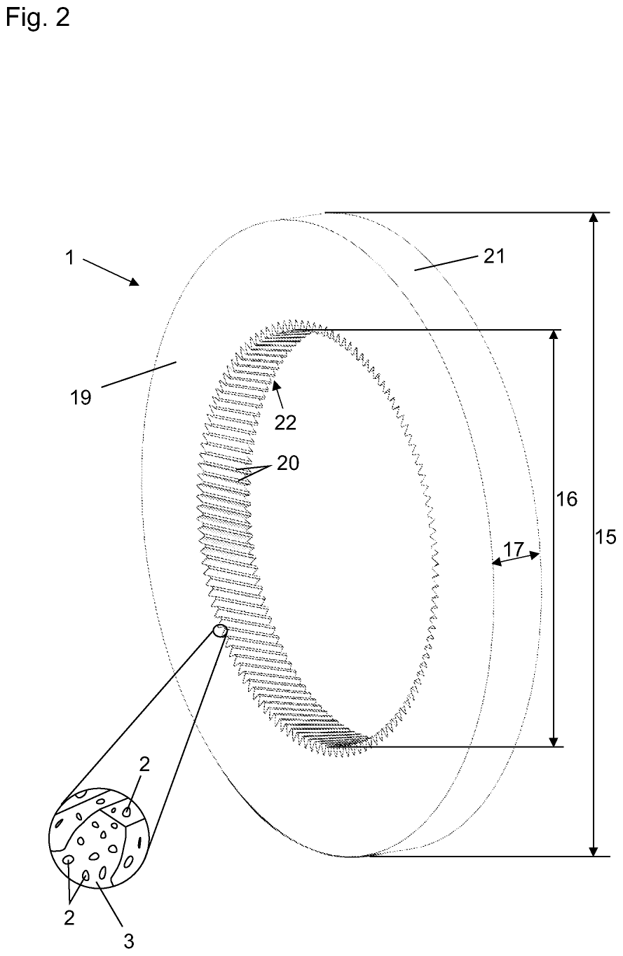

FIG. 2 a perspective view of a ceramically bonded grinding tool according to a particularly preferred embodiment example.

FIG. 1 shows a method for producing a ceramically bonded grinding tool 1 (cf. FIG. 2) in the form of a honing ring, wherein in a first method step, an abrasive 2, for example corundum, SiC, aluminum oxide, and/or a superabrasive, together with an inorganic bonding material 3, for example for low-temperature baking bonding, and an organic bonding material 4, for example in the form of epoxy resin, are provided and blended. Generally, the mass for forming the grinding tool blank 10 can be blended in a press mold 12 of a cold-pressing step 5 or separately. The individual constituents of the mass for forming a grinding tool blank 10 can generally be present in pure form or in a mixture; for example, the abrasive 2 can be composed of corundum and a superabrasive.

The abrasive 2, the inorganic bonding material 3 and the organic bonding material 4 are pre-pressed in the cold-pressing step 5 to form a cold-pressed green body 6, which is indicated schematically to the right of the press mold 12 of the cold-pressing step 5. The cold-pressed green body 6 has a central through-opening, which however is generally not absolutely necessary. The cold-pressed green body 6 is pressed to a first extent 13 in the cold-pressing step 5.

In a hot-pressing step 7, the cold-pressed green body 6 is pressed to form a hot-pressed green body 8, as a result of which the production process for the grinding tool blank 10 is subject to a two-stage pressing process.

In this embodiment example, a pressure of 50 bar and room temperature are used in the cold-pressing step 5.

In the hot-pressing step 7, the hot-pressed green body 8 is pressed to a second extent 14 that is different from the first extent 13. The hot-pressed green body 8, which is indicated schematically to the right of the press mold 12 of the hot-pressing step 7, has been pressed to an external diameter 15 of 300 mm, an internal diameter 16 of 138 mm, and a width 17 of 27 mm, wherein the method is able to be adapted to any geometries and dimensions of the grinding tool blank 10 by means of press molds 12 and operating parameters, such as pressure and temperature, required for this.

The cold-pressing step 5 and the hot-pressing step 7 are carried out in separate press molds 12, wherein the press mold 12 and the cold-pressed green body 6 are pre-heated for the hot-pressing step 7.

According to this embodiment, a pressure of 280 bar and a temperature of 180° C. are used in the hot-pressing step 7.

Generally, the pressures and/or temperatures can vary during the pressing steps 5, 7 and/or the firing step 9, wherein it is possible to adjust characteristic material properties of the grinding tool blank 10 by using a pressure curve or temperature curve.

The organic bonding material 4 is entirely cross-linked during the hot-pressing step 7.

The hot-pressed green body 8 is fired in a firing step 9 to form the grinding tool blank 10, in the form of a honing ring blank, wherein the organic bonding material 4, in the form of epoxy resin, is partly burned off during the firing step 9.

In the firing step 9, the inorganic bonding material 3 is fused, wherein the firing step 9 is carried out in a furnace 18. In this embodiment example, the firing step 9 is carried out at a temperature of 950° C.

During the firing step 9, the organic bonding material 4 in the form of epoxy resin is burned off to such an extent that an organic bond volume amounts to 10 vol. % of the grinding tool blank 10.

In the embodiment shown, starting from a grain volume of an abrasive 2, a bond volume of the bonding materials 3, 4, and a pore volume of the cold-pressed green body 6 after the cold-pressing step 5, as a result of the hot-pressing step 7 and the firing step 9
the grain volume of the grinding tool blank 10 is increased to 55 vol. %,
a bond volume of the grinding tool blank 10 is increased to 20 vol. % despite the process of burning off epoxy resin in the firing step 9, and
a pore volume of the grinding tool 1 is reduced to 25 vol. %,
   wherein the grain volume, the bond volume and the pore volume of the hot-pressed green body 8 and of the grinding tool blank 10 together amount to 100 vol. % in each case.

The grinding tool blank 10 is post-processed in a subsequent method step 11 to form the grinding tool 1, in which abrasive 2 is embedded.

FIG. 2 shows a ceramically bonded grinding tool 1 in the form of a honing ring which was produced using a method according to FIG. 1. The grinding tool 1 comprises a main body 19 and the abrasive 2, which is embedded in the main body 19 by means of the inorganic bonding material 3.

The main body 19 is annular and formed in one piece, wherein the main body 19 has teeth 22 on an inner lateral surface 20, which teeth can be brought into contact with a toothed workpiece. Generally, the teeth 22 can also be arranged on an outer lateral surface 21.

The abrasive 2 consists of a mixture of superabrasives in the form of diamond and cubic boron nitride, wherein the abrasive 2 alternatively or additionally is able to comprise other abrasives 2.

The grinding tool 1 has the dimensions of the fired grinding tool blank 10 according to FIG. 1, wherein it is generally possible for slight shrinkage to occur during the firing step 9. The external diameter 15 is 300 mm, the internal diameter 16 is 138 mm, and the width 17 is 27 mm.

The grain volume of the abrasive 2 is 55 vol. % of the grinding tool 1, the bond volume of the bonding materials 3, 4 is 20 vol. % of the grinding tool 1, and the pore volume is 25 vol. % of the grinding tool 1.

The grinding tool 1 comprises 10 vol. % organic bond volume, wherein the organic bond volume is present as epoxy resin from the group of thermoplastics and thermosets.

The grinding tool 1 comprises an inorganic bonding material 3, wherein the inorganic bonding material 3 is developed in the form of a low-temperature baking bond, wherein the low-temperature baking bond comprises SiO₂, Al₂O₃, B₂O₃ and oxides of alkalis and alkaline earths.

1. A method for producing a ceramically bonded grinding tool, in particular a honing ring, comprising the following method steps, to be carried out in chronological order:
in a first method step, at least one abrasive, in particular corundum, SiC, aluminum oxide, and/or a superabrasive, at least one inorganic bonding material, in particular formed as a low-temperature baking bond, and at least one organic bonding material, in particular in the form of epoxy resin, are provided and blended,
the at least one abrasive, the at least one inorganic bonding material and the at least one organic bonding material are pre-pressed in a cold-pressing step to form a cold-pressed green body,
the cold-pressed green body is pressed in a hot-pressing step to form a hot-pressed green body,
the hot-pressed green body is fired in a firing step to form a grinding tool blank, in particular a honing ring blank, wherein the at least one organic bonding material is at least partly burned off during the firing step, and
the grinding tool blank is post-processed in a subsequent method step to form the grinding tool, in which abrasive is embedded.

2. The method according to claim 1, wherein the at least one organic bonding material is substantially entirely burned off during the firing step and/or is burned off to such an extent that an organic bond volume is at most 15 vol. %, preferably at most 10 vol. %, of the grinding tool blank.

3. The method according to claim 1, wherein the cold-pressing step and the hot-pressing step are carried out in separate press molds, wherein it is preferably provided that the press mold and/or the cold-pressed green body is/are pre-heated for the hot-pressing step.

4. The method according to claim 1, wherein the cold-pressed green body is pressed to a first extent in the cold-pressing step and the hot-pressed green body is pressed to a second extent that is different from the first extent in the hot-pressing step, wherein it is preferably provided that the hot-pressed green body is pressed to an external diameter between 50 mm and 450 mm, an internal diameter between 20 mm and 300 mm, and/or a width between 10 mm and 90 mm.

5. The method according to claim 1, wherein the at least one organic bonding material is substantially fully cross-linked in the hot-pressing step.

6. The method according to claim 1, wherein the at least one inorganic bonding material is fused in the firing step, wherein it is preferably provided that the firing step is carried out in a furnace.

7. The method according to claim 1, wherein a pressure between 20 bar and 300 bar, preferably between 40 bar and 60 bar, and/or substantially room temperature is/are used in the cold-pressing step.

8. The method according to claim 1, wherein a pressure between 270 bar and 310 bar, preferably 275 bar to 285 bar, and/or a temperature between 150° C. and 200° C., preferably between 170° C. and 180° C., is/are used in the hot-pressing step.

9. The method according to claim 1, wherein the firing step is carried out at a temperature between 600° C. and 1300° C., preferably between 900° C. and 1000° C.

10. The method according to claim 1, wherein, starting from a grain volume of an abrasive, a bond volume of the bonding materials, and/or a pore volume of the cold-pressed green body after the cold-pressing step, as a result of the hot-pressing step and/or the firing step
the grain volume of the grinding tool blank is increased to a range between 50 vol. % and 65 vol. %, preferably between 53 vol. % and 58 vol. %, and/or
a bond volume of the grinding tool blank is increased to a range between 10 vol. % and 35 vol. %, preferably between 18 vol. % and 26 vol. %, and/or
a pore volume of the grinding tool is reduced to a range between 10 vol. % and 40 vol. %, preferably between 22 vol. % and 28 vol. %,
wherein the grain volume, the bond volume and the pore volume of the hot-pressed green body and/or of the grinding tool blank together amount to at most 100 vol. %.

11. A ceramically bonded grinding tool, in particular a honing ring,
comprising
a main body and
at least one abrasive that is embedded in the main body by means of at least one inorganic bonding material,
wherein
a grain volume of the abrasive is in the range between 50 vol. % and 65 vol. %, in particular between 53 vol. % and 58 vol. %, and
a bond volume of a bonding material is in the range between 10 vol. % and 35 vol. %, in particular between 18 vol. % and 26 vol. %,
of the grinding tool, wherein the grain volume and the bond volume together amount to at most 100 vol. % of the grinding tool.

12. A grinding tool is produced by the method according to claim 1.

13. The grinding tool according to claim 11, wherein the main body is annular and/or formed in one piece, wherein it is preferably provided that the main body has teeth on an inner lateral surface and/or on an outer lateral surface, which teeth can be brought into contact with a toothed workpiece.

14. The grinding tool according to claim 11, wherein the at least one abrasive is formed at least in part, preferably entirely, of corundum, preferably high-grade corundum and/or sintered corundum, SiC, aluminum oxide, and/or a superabrasive, preferably diamond and/or cubic boron nitride.

15. The grinding tool according to claim 11, wherein the grinding tool comprises at most 15 vol. %, preferably at most 10 vol. %, organic bond volume, wherein it is preferably provided that the organic bond volume is formed from the group of thermoplastics and/or thermosets, particularly preferably substantially epoxy resin.

16. The grinding tool according to claim 11, wherein the grinding tool comprises at least one, preferably exactly one, inorganic bonding material, wherein the at least one inorganic bonding material is in the form of a low-temperature baking bond.

17. The grinding tool according to claim 16, wherein the at least one inorganic bonding material comprises SiO₂, Al₂O₃, B₂O₃, and/or at least one oxide comprising an alkali and/or alkaline earth.

18. The grinding tool according to claim 11, wherein the grinding tool has an external diameter between 50 mm and 450 mm, an internal diameter between 20 mm and 300 mm, and/or a width between 10 mm and 90 mm.

19. The grinding tool according to claim 11, wherein the grinding tool comprises a pore volume in the range between 10 vol. % and 40 vol. %, preferably between 22 vol. % and 28 vol. %, wherein the grain volume, the bond volume and the pore volume together amount to at most 100 vol. % of the grinding tool.
